(19) United States
(12) Patent Application Publication
(10) Pub. No.: US 2011/0160358 A1
(43) Pub. Date: Jun. 30, 2011

(54) Water-based pigment dispersion for inkjet recording water-based ink, inkjet recording water-based ink, and water-based ink set

(75) Inventors: Masamitsu Arai, Ibaraki (JP); Kengo Yasui, Ibaraki (JP); Yuuya Enomoto, Ibaraki (JP); Toshihiro Seki, Ibaraki (JP)

(73) Assignee: DIC Corporation, Tokyo (JP)

(21) Appl. No.: 12/971,855

(22) Filed: Dec. 17, 2010

(30) Foreign Application Priority Data
Dec. 25, 2009 (JP) 2009-293798

(51) Int. Cl. C08K 5/3437

(52) U.S. Cl. 524/90

(57) ABSTRACT

[Object] To provide a water-based pigment dispersion for an inkjet recording water-based ink with which color recording images excellent, in terms of color development property, light resistance, and ejection durability are obtained; such an inkjet recording water-based ink; and a water-based ink set including such a water-based ink and a polyvalent metal salt solution.

[Solving Means] A water-based pigment dispersion for an inkjet recording water-based ink and an inkjet recording water-based ink includes an organic pigment (A) and an anionic-group-containing organic polymer compound (B) in a water-based medium (C), wherein, as the water-based pigment dispersion, a water-based pigment dispersion in which the organic pigment (A) is a red pigment composed of a disubstituted quinacridone and a water-based pigment dispersion in which the organic pigment (A) is C. I. Pigment Red 269 are used in combination. An inkjet recording water-based ink set includes a polyvalent metal salt solution and such an inkjet recording water-based ink.

### TECHNICAL FIELD

The present invention relates to a water-based pigment dispersion for an inkjet recording water-based ink with which color recording images excellent in terms of color development property, light resistance, and ejection durability are obtained; such an inkjet recording water-based ink; and a water-based ink set including such a water-based ink and a polyvalent metal salt solution.

### BACKGROUND ART

There is a tendency that an inkjet recording system is used for wider applications from home use to office use, photographic use, and outdoor use. With such a tendency, weather (light) resistance and storability of printed products have come to be regarded as being important. Dyes, which have been primarily used as colorants for inkjet recording, have many problems in light resistance. Accordingly, water-based inks for inkjet recording are being developed with pigments, which are excellent in terms of light resistance.

As pigments used for magenta water-based inks for inkjet, for example, thioindigo pigments, soluble azo lake pigments, insoluble azo pigments, quinacridone pigments, and the like have been used. Of these, in particular, quinacridone pigments (C. I. Pigment Violet 19, C. I. Pigment Red 122, and the like), which are considerably excellent in terms of light resistance of color recording images, are often used.

However, they themselves are too blue for magenta and have a low color optical density. As for hue, they are often adjusted by being mixed with yellower red colorants and used as magenta. As a typical example, there is a solid solution pigment of two or more quinacridone pigments.

As an inkjet recording water-based ink in which such a quinacridone solid solution pigment is used, for example, water-based ink for inkjet recording is known that indispensably contains, a solid solution pigment composed of a dimethylquinacridone pigment such as C. I. Pigment Red 122 and an unsubstituted quinacridone pigment (Patent Document 1). However, when two or more quinacridone pigments only are mixed together or made to form a solid solution, the color development property of color recording images with the resultant water-based inks is insufficient.

As for an insoluble monoazo pigment, it is known that an inkjet recording water-based ink in which C. I. Pigment Red 269 is used provides color recording images having an excellent, color development property (Patent Document 2). However, the light resistance of color recording images with the water-based ink cannot be said as being sufficient.

Accordingly, attempts to prepare water-based inks for inkjet recording by using, in combination with a mixture of quinacridone pigments or a solid solution pigment of quinacridone pigments, a red pigment having a chemical structure different from that of quinacridone have been studied (Patent Documents 3 to 5).

However, even when such different pigments are used in combination to prepare water-based inks for inkjet recording, the color development property and light resistance of the resultant color recording images generally reach merely the arithmetic-mean level of the color development property and light resistance of color recording images obtained with inkjet recording water-based inks that contain either of the two pigments. Thus, color recording images having sufficiently high color development property and light resistance are not provided yet.

In addition, in a printing durability test with an inkjet printer, in the case where an attempt to provide a large number of printed products is made, a problem occurs in the capability of ejecting an inkjet recording water-based ink before the intended number is reached, and poor coverage, omission, or the like occurs in printed images. Accordingly, ejection durability is not satisfactory.

Inkjet recording water-based inks having a physical property of being highly permeable to recording media are used in consideration of the fixing speed of the inks and bleeding between colors. Accordingly, pigments of the inks permeate inside recording media and the amount of the pigments fixed on the surfaces is not sufficiently ensured. Thus, it is difficult to provide color recording images having a high color development property. To address this, for example, studies have been made in which various coat layers are provider on the surfaces of recording media to suppress permeation of pigments and enhance the color development property. Such recording media having various coat layers are sold as, for example, paper sheets specifically designed for inkjet recording. As a measure in terms of an ink, a method is known that, by using a reaction solution that reacts with a colorant in an ink, the colorant is precipitated or aggregated to achieve solid-liquid separation to thereby increase the fixing amount on the surfaces of recording media.

As such measures in terms of an ink, an inkjet recording water-based ink set including an inkjet recording water-based ink containing a pigment and a publicly known and commonly used anionic-group-containing organic polymer compound and a polyvalent metal salt solution; and an inkjet recording method in which the ink set is used to perform recording on recording media by an inkjet recording system are known (Patent Documents 6 and 7).

However, inkjet recording water-based inks themselves are not satisfactory in terms of color development property, light resistance, and ejection durability for continuous printing. Accordingly, even when color images are obtained with an inkjet recording water-based ink, set including such an ink and a polyvalent metal salt solution, the color development property, light resistance, and election durability for continuous printing are also not satisfactory.

That is, even when inkjet recording is performed on plain paper sheets that are not paper sheets specifically designed for inkjet recording by the method described in Patent Documents 6 and 7 with an inkjet recording water-based ink set including an inkjet recording water-based magenta ink described in Patent Documents 1 to 5 and a polyvalent metal salt solution, ejection durability for continuous printing is not satisfactory and the color development property and light resistance of magenta recording images that are inkjet recorded with the ink set are also not satisfactory.
[Patent Document 1] Japanese Unexamined Patent Application Publication No. 11-49998
[Patent Document 2] Japanese Unexamined Patent Application Publication No. 2000-186241
[Patent Document 3] Japanese Unexamined Patent Application Publication No. 2000-181144
[Patent Document 4] Japanese Unexamined Patent Application Publication No. 2001-2962
[Patent Document 5] Japanese Unexamined Patent Application Publication. No. 2003-292812
[Patent Document 6] Japanese Unexamined Patent Application Publication No. 3-240557
[Patent Document 7] Japanese Unexamined Patent Application Publication No. 5-202328

### DISCLOSURE OF THE INVENTION

### Problems to be Solved by the Invention

An object of the present invention is to provide a water-based pigment dispersion for an inkjet recording water-based ink that is more excellent in terms of ejection durability for continuous printing and provides color recording images that are excellent in terms of color development property and light resistance by inkjet recording on plain paper sheets; such an inkjet recording water-based ink; and a water-based ink set including such a water-based ink and a polyvalent metal salt solution.

### Means for Solving the Problems

The inventors of the present invention have performed thorough studies in view of the above-described circumstances. As a result, the inventors have found that, by using, as magenta organic pigments contained in an inkjet recording water-based ink, both a red pigment composed of a disubstituted quinacridone and C. I. Pigment. Red 269 not in the form of pigments but in the form of water-based pigment dispersions, the dispersions provide a synergistic effect and, as a result, more excellent ejection durability for continuous printing is achieved and color recording images that are excellent in terms of color development property and light resistance can be obtained on plain paper sheets. Thus, the present invention has been accomplished.

Specifically, the present invention provides a water-based pigment dispersion for an inkjet recording water-based ink, containing an organic pigment (A) and an anionic-group-containing organic polymer compound (B) in a water-based medium (C), wherein, as the water-based pigment dispersion, a water-based pigment dispersion in which the organic pigment (A) is a red pigment composed of a disubstituted quinacridone and a water-based pigment dispersion in which the organic pigment (A) is C.I. Pigment Red 269 are used in combination.

The present invention also provides an inkjet recording water-based ink prepared by at least diluting the water-based pigment dispersion in a liquid medium.

Furthermore, the present invention provides an inkjet recording water-based ink set containing a polyvalent metal salt solution and the inkjet recording water-based ink.

### ADVANTAGES

In a water-based pigment dispersion for an inkjet recording water-based ink according to the present invention, a water-based pigment dispersion prepared solely from a red pigment composed of a disubstituted quinacridone and a water-based pigment dispersion prepared solely from C. I. Pigment Red 269 are used in combination. Accordingly, considerably remarkable technical advantages, which cannot be achieved with a water-based pigment dispersion prepared with a water-based pigment dispersion prepared from a pigment mixture obtained by mixing the pigments in advance, can be achieved: ejection durability for continuous printing can be achieved; and an inkjet recording water-based ink that provides color recording images that are good in terms of color development property and light resistance can be prepared.

An inkjet recording water-based ink according to the present invention is prepared with the water-based pigment dispersion and hence provides considerably remarkable technical advantages: ejection durability for continuous printing is excellent and good color recording images that are excellent in terms of color development property and light resistance can be provided.

In addition, such excellent color development property and light resistance of color recording images are achieved not only in color recording images obtained solely with the inkjet recording water-based ink but also similarly with an inkjet recording water-based ink set in which the inkjet recording water-based ink is combined with a polyvalent metal salt solution.

### BEST MODE FOR CARRYING OUT THE INVENTION

Hereinafter, the present invention will be described in detail.

The present invention provides a water-based pigment dispersion for an inkjet recording water-based ink, containing an organic pigment (A) and an anionic-group-containing organic polymer compound (B) in a water-based medium (C), wherein, as the water-based pigment dispersion, a water-based pigment dispersion in which the organic pigment (A) is a red pigment composed of a disubstituted quinacridone and a water-based pigment dispersion in which the organic pigment (A) is C. I. Pigment Red 269 are used in combination.

A water-based pigment dispersion for an inkjet recording water-based ink, containing a red pigment composed of a disubstituted quinacridone and an anionic-group-containing organic polymer compound (B) in a water-based medium (C); a water-based pigment dispersion for an inkjet recording water-based ink, containing C. I. Pigment Red 269 and an anionic-group-containing organic polymer compound (B) in a water-based medium (C), the dispersions being used to prepare a water-based pigment dispersion according to the present invention; or a water-based pigment dispersion for an inkjet recording water-based ink according to the present invention in which the water-based pigment dispersions are used in combination, is sometimes simply referred to as a water-based pigment dispersion according to the present invention.

In the present invention, as the organic pigment WI, a red pigment composed of a disubstituted quinacridone and C. I. Pigment Red 269 are used. Here, the red pigment composed of a disubstituted quinacridone is a quinacridone pigment having a chemical structure in which two hydrogen atoms on substitutable benzene rings in unsubstituted quinacridone are replaced with atomic groups other than hydrogen. Such two substituents are, for example, methyl groups, methoxy groups, chlorine atoms, or the like. Typical red pigments composed of a disubstituted quinacridone are, for example, a 2,9-dimethylquinacridone pigment (C. I. Pigment Red 122) and a 2,9-dichloroquinacridone pigment (C. I. Pigment Red 202). Naturally, such a red pigment encompasses a solid solution pigment that contains a disubstituted quinacridone as an essential component, for example, a quinacridone solid solution pigment that contains unsubstituted quinacridone and 2,9-dichloroquinacridone such that the content of the former is higher in mass ratio.

As such a red pigment composed of a disubstituted quinacridone, at least one red pigment selected from the group consisting of C.I. Pigment Red 122, C.I. Pigment Red 202, and a quinacridone solid solution pigment including, in the chemical structure, at least one of C. I. Pigment Red 122 and C. I. Pigment. Red 202 is preferred because of excellent light resistance of color recording images. As a red pigment composed of a disubstituted quinacridone, for example, compared with a quinacridone solid solution pigment that contains C. I. Pigment Red 202 in the chemical structure, C.I. Pigment. Red 122 in combination with C. I. Pigment. Red 269 provides a high synergistic effect in terms of color development property in two-liquid printed products with an inkjet recording ink set including such a combination and a polyvalent metal salt aqueous solution described below.

C.I. Pigment Red 269 is an insoluble monoazo red pigment. Although various insoluble monoazo red pigments other than C. I. Pigment Red 269 are known, only C. I. Pigment Red 269 provides a synergistic effect in terms of hue, light resistance, or the like in combination with the red pigment composed of a disubstituted quinacridone.

Use of a red pigment composed of a disubstituted quinacridone and C. I. Pigment Red 269 that are fine in terms of average primary particle diameter, which is suitable for the preparation of an inkjet recording water-based ink, is preferred in view of the preparation of a water-based pigment dispersion for an inkjet recording water-based ink and also the inkjet recording water-based ink. In addition, these preferably contain, as less as possible, mutagenic materials, various salts of metals such as calcium, other organic impurities, by-products, or the like, in view of safety and also election property.

In the present invention, a water-based pigment dispersion for an inkjet recording water-based ink, containing a red pigment composed of a disubstituted quinacridone and an anionic-group-containing organic polymer compound (B) in a water-based medium (C); and a water-based pigment dispersion for an inkjet recording water-based ink, containing C. I. Pigment Red 269 and an anionic-group-containing organic polymer compound (B) in a water-based medium (C), are used in combination. An inkjet recording water-based ink according to the present invention is prepared from a mixture of these water-based pigment dispersions.

For convenience, it is possible to obtain a water-based pigment dispersion for an inkjet recording water-based ink by preparing a pigment composition in which a red pigment composed of a disubstituted quinacridone and C. I. Pigment Red 269 are mixed in advance and then making the pigment composition and an anionic-group-containing organic polymer compound (B) be contained in a water-based medium (C). However, a water-based pigment dispersion obtained in this manner has a large amount of coarse particles. Therefore, unless water-based pigment dispersions individually prepared with the pigments are used in combination as in the present invention, the remarkable advantages in the present invention cannot be achieved.

The inventors of the present invention have found that, since a red pigment composed of a disubstituted quinacridone and C. I. Pigment Red 269 are different in terms of pigment properties such as chemical structure, crystalline structure, average particle diameter, particle size distribution, and hardness and these pigments are also different in terms of compatibility with an anionic-group-containing organic polymer compound (B) and a water-based medium (C) that are used in the preparation of water-based pigment dispersions, when water-based pigment dispersions are prepared by mixing the pigments in advance, excellent properties that the pigments inherently have are not effectively utilized. The inventors of she present invention consider that this is probably caused because a dispersion condition for maximizing the properties of a red pigment composed of a disubstituted quinacridone is different from a dispersion condition for maximizing the properties of C. I. Pigment Red 269 and these dispersion conditions do not have an overlapping region and, as a result, the pigments provide insufficient properties under a single dispersion condition.

A mixing ratio in the case of using water-based pigment dispersions in combination is not particularly restricted. However, in representation with a ratio in terms of pigments themselves, for example, satisfying red pigment composed of disubstituted quinacridone/C. I. Pigment Red 269 (mass ratio)=90/10 to 20/80 provides excellent election durability for continuous printing and color recording images that are good in terms of color development property and light resistance in the case of using the two pigments in combination; in particular, a range of 85/15 to 45/55 is more preferable in which excellent color development property and light resistance are achieved; and, furthermore, a range of 75/25 to 60/40 is still more preferable in which considerably excellent color development property and light resistance are achieved.

Note that, the term “excellent color development property and light resistance” denotes the case where two-liquid printed products have an O. D. of 1.30 or more and a ΔE of less than 25.0; and the term “considerably excellent color development property and light resistance” denotes the case where two-liquid printed products have an O. D. of 1.40 or more and a ΔE of less than 10.0.

If necessary, a water-based pigment dispersion for an inkjet recording water-based ink, containing a red pigment composed of a disubstituted quinacridone and an anionic-group-containing organic polymer compound (B) in a water-based medium (C); and a water-based pigment dispersion for an inkjet recording water-based ink, containing C. I. Pigment Red 269 and an anionic-group-containing organic polymer compound (B) in a water-based medium (C), may contain another organic pigment as long as excellent advantages of the water-based pigment dispersions are not degraded.

A water-based pigment dispersion for an inkjet recording water-based ink according to the present invention can be prepared by making the organic pigment (A) and an anionic-group-containing organic polymer compound (B) be contained as essential components in a water-based medium (C).

The anionic-group-containing organic polymer compound (B) is, for example, an organic polymer compound including a carboxyl group, a sulfonic grout, or a phosphate group. Such an anionic-group-containing organic polymer compound is, for example, a copolymer of (meth)acrylic acid and another ethylenically unsaturated monomer that is copolymerizable with the (meth)acrylic acid in view of the preparation of the compound and abundance and availability of monomer products. Note that (meth)acrylic acid in the present invention is a generic term denoting acrylic acid and methacrylic acid. The same understanding applies to various esters of (meth)acrylic acid.

Examples of an ethylenically unsaturated monomer that is usable together with, other than, and copolymerizable with (meth)acrylic acid include monoethylenically unsaturated monomers such as styrene, α-methyl styrene, dimethyl styrene, tert-butyl styrene, chlorostyrene, benzyl (meth)acrylate, phenyl (meth)acrylate, phenylethyl (meth)acrylate, phenylpropyl (meth)acrylate, phenoxyethyl (meth)acrylate, methyl (meth)acrylate, ethyl (meth)acrylate, n-propyl (meth)acrylate, iso-propyl (meth)acrylate, n-butyl (meth)acrylate, iso-butyl (meth)acrylate, trt-butyl (meth)acrylate, 2-ethylhexyl (meth)acrylate, n-octyl (meth)acrylate, dodecyl (meth)acrylate, octadecyl (meth)acrylate, cyclohexyl (meth)acrylate, isobornyl (meth)acrylate, 2-hydroxyethyl (math) acrylate, hydroxypropyl (meth)acrylate, methoxy polyethylene glycol mono(meth)acrylate, and methoxy poly(oxyethylene oxypropylene) glycol mono(meth)acrylate.

Examples of the copolymer include styrene-(meth)acrylic acid copolymers, styrene-(meth)acrylate-(meth)acrylic acid copolymers, and (meth)acrylate-(meth)acrylic acid copolymers. Such copolymers preferably have an acid value of 40 to 220 mgKOH/g, in particular, an acid value of 90 to 200 mgKOH/g, which results in better dispersibility and dispersion stability in water and glossiness in printed products. Here, the acid value is the value in mg of potassium hydroxide that requires to neutralize 1 g of non-volatile matter of a copolymer. A theoretical acid value can also be arithmetically determined on the basis of (meth)acrylic acid used and the amount of the (meth) acrylic acid used. When the acid value is too low, pigment dispersibility or storage stability is degraded and, when an inkjet recording water-based ink described below is prepared, printing stability is degraded, which is not preferable. When the acid value is too high, the water resistance of color recording images is degraded, which is also not preferable. When a copolymer is made to have an acid value within such a range, copolymerization is performed such that (math) acrylic acid contained has an acid value within the range.

To enhance hydrophobicity of a copolymer with respect to the same acid value to make adhesion of the copolymer to pigment surfaces be stronger, as the other copolymerizable ethylenically unsaturated monomer, for example, a (meth)acrylate monomer having a benzene ring such as benzyl (meth)acrylate, phenyl (meth)acrylate, phenylethyl (meth)acrylate, phenylpropyl (meth)acrylate, or phenoxyethyl (meth)acrylate is preferably used and, in particular, a styrene monomer such as styrene, α-methyl styrene, or tert-butyl styrene is preferably used.

A copolymer in the present invention should be a copolymer that includes, as essential polymerization units, a polymerization unit of (methacrylic acid and a polymerization unit of another copolymerizable ethylenically unsaturated monomer, and may be a binary copolymer of these or a multicomponent copolymer that is ternary or more and further includes still another copolymerizable ethylenically unsaturated monomer.

A copolymer used in the present invention may be a linear copolymer solely constituted by a polymerization unit of monoethylenically unsaturated monomers or a copolymer including a partially crosslinked structure in which ethylenically unsaturated monomers having various crosslinkability are copolymerized to a considerably small degree.

Examples of such ethylenically unsaturated monomers having crosslinkability include glycidyl (math) acrylate, divinylbenzene, and poly(meth)acrylates of polyhydric alcohols such as ethylene glycol di(meth)acrylate, propylene glycol di(meth)acrylate, polyethylene glycol di(meth)acrylate, poly(oxyethylene oxypropylene) glycol di(meth)acrylate, and tri(meth)acrylate of alkylene oxide adducts of glycerin.

The molecular weight of a copolymer in the present invention is not particularly restricted; however, the molecular weight is preferably, for example, a weight average molecular weight of 5,000 to 1,000,000 in view of a film-formation property, in particular, 5,000 to 20,000 in view of a low viscosity and ease of handling.

In the present invention, monomers used are regarded as having substantially the same reaction percentage and the like, and the proportions of the monomers charged are viewed as the contents of polymerization units of the monomers in terms of mass. Copolymers in the present invention can be synthesized by publicly known various reaction methods such as block polymerization, solution polymerization, suspension polymerization, and emulsion polymerization. In such a case, a polymerization initiator, a chain transfer agent (polymerization degree adjusting agent), a surfactant, and an antifoaming agent that are publicly known and commonly used may also be used.

A copolymer (b) that is substantially linear is suitable for preparing a water-based ink for an inkjet recording apparatus having piezo-system nozzles not causing thermal hysteresis. In contrast, a copolymer (b) including a crosslinked structure is suitable for preparing a water-based ink for an inkjet recording apparatus having thermal-system nozzles causing thermal hysteresis.

When a copolymer has a high acid value or a high dispersibility is not demanded, only a copolymer may be used. However, in the other cases, a water-based pigment dispersion for an inkjet recording water-based ink or an inkjet recording water-based ink that are more excellent in terms of dispersibility can be generally prepared by neutralizing anionic groups included in a copolymer by using a basic substance.

As the basic substance for neutralizing a copolymer, any publicly known and commonly used basic substance can be used: for example, an inorganic basic substance such as sodium hydroxide, potassium hydroxide, or ammonia or an organic basic substance such as triethylamine or alkanolamine may be used. The amount of such a basic substance used may be appropriately adjusted in accordance with the amount of anionic groups included in a copolymer. In the case of a copolymer having a small amount of anionic groups, neutralization may be performed with an amount with which all the anionic groups are neutralized or with an amount that is excessive and beyond she amount of the anionic groups. In the case of a copolymer having a large amount of anionic groups, a part of the anionic groups may be neutralized.

A water-based medium in the present invention is a liquid medium containing water as an essential component and a main component. As the water, for example, a water that has a pH of 6.5 to 7.5 and does not contain free ions is preferred, such as distilled water, ion-exchanged water, pure water, or ultrapure water.

A water-based pigment dispersion for an inkjet recording water-based ink, containing a red pigment composed of a disubstituted quinacridone and an anionic-group-containing organic polymer compound (B) in a water-based medium (C); a water-based pigment dispersion for an inkjet recording water-based ink, containing C.I. Pigment Red 269 and an anionic-group-containing organic polymer compound (B) in a water-based medium (C), the dispersions being used to prepare a water-based pigment dispersion according to the present invention; or a water-based pigment dispersion for an inkjet recording water-based ink according to the present invention in which the water-based pigment dispersions are used in combination, preferably has, on a mass basis, non-volatile matter of the anionic-group-containing organic polymer compound (B)/organic pigment of more than 0.2 and 2.0 or less, particularly more preferably more than 0.2 and 1.0 or less, and particularly most preferably more than 0.20 and 0.65 or less. When this ratio is too low, resistance to scratching in color recording images and the dispersion stability of a water-based ink itself are degraded; when the ratio is too high, the viscosity of a water-based ink is increased and the election stability of the ink tends to be degraded, which are not preferred. When the total non-volatile matter of copolymer (B)/organic pigment (A) is 0.2 or less, dispersion stability tends to be insufficient, which is not preferred.

A water-based pigment dispersion for an inkjet recording water-based ink in the present invention can be prepared by a publicly known and commonly used method and can be prepared by mixing an organic pigment (A), an anionic-group-containing organic polymer compound (B), and water as essential components. In this mixing, any of apparatuses that are publicly known and of various systems can be used.

A water-based pigment dispersion for an inkjet recording water-based ink and an inkjet recording water-based ink described below in the present invention may further contain a polyester resin and a polyurethane resin that are publicly known and commonly used and other than the copolymer described above in detail, or an aqueous solution or an aqueous dispersion of such a resin. Polyurethane in the present invention encompasses not only resins solely having urethane bonds but also resins further having urea bonds. Anionic-group-containing polyurethane resins are suitable for enhancing the resistance to scratching in color recording images. Examples of such anionic-group-containing polyurethane resins include carboxyl-group-containing polyester urethane, carboxyl-group-containing polyester urethane, and carboxyl-group-containing polyether ester urethane. In particular, carboxyl-group polyether ester urethane having no ester bonds and carboxyl-group-containing polyether ester urethane in which the number of ester bonds is smaller than that of ether bonds are preferably used because of excellent resistance to hydrolysis. Such anionic groups can also be neutralized with the above-described basic substances.

An inkjet recording water-based ink in the present invention can be prepared by, for example, mixing and diluting a water-based pigment dispersion that is obtained in the above-described manner and has a higher pigment concentration and a higher non-volatile matter concentration of an anionic-group-containing organic polymer compound, various additives that are publicly known and commonly used in the technical field of inkjet recording water-based pigment inks, and a liquid medium. Alternatively, an inkjet recording water-based ink in the present invention can be prepared by, not through the above-described water-based pigment dispersion that has a higher pigment concentration and a higher non-volatile matter concentration of an anionic-group-containing organic polymer compound, but directly mixing an organic pigment (A), an anionic-group-containing organic polymer compound (B), and water that serve as essential components, various additives that are publicly known and commonly used in the technical field of inkjet recording water-based pigment inks, and a liquid medium.

Specifically, a water-based ink can be prepared by using, in combination, water, another liquid medium such as a water-soluble organic solvent, various additives such as a wetting agent, a fungicide, and a pH regulator such that the solid matter of an organic pigment (A) is 1% to 10% on a mass basis. In addition, if necessary, the resultant water-based ink is subjected to ultracentrifugation or filtration through a microfilter to thereby remove coarse particles or excessively small particles or adjust the particle size distribution of dispersed particles. Thus, the occurrence of nozzle clogging or the like can be considerably reduced.

When, as an anionic-group-containing organic polymer compound (B), a copolymer of (meth) acrylic acid and another ethylenically unsaturated monomer that is copolymerizabie with the (meth) acrylic acid and an anionic-group-containing polyurethane resin are used in combination, for example, there may be a preparation method in which the copolymer and the polyurethane resin are separately used to prepare water-based pigment dispersions or water-based inks and a final water-based ink is prepared from the dispersions or inks. A water-based pigment dispersion of a microencapsulated pigment in which an organic pigment (A) is covered with an anionic-group-containing organic polymer compound can be prepared by using the above-described raw materials by, for example, in advance, a publicly known and commonly used phase-inversion emulsification method or acid precipitation method below.

The phase-inversion emulsification method is described in Japanese Patent No. 3301082. When microcapsules in which an organic pigment is encapsulated with a resin are produced, a mixture of a carboxyl-group-containing organic polymer compound, an organic pigment, and an organic solvent is used as an organic phase and the organic phase is put into a water-based medium in which a basic compound has been dissolved or the organic phase is mixed with a basic compound and water is then put into the organic phase, to neutralize the carboxyl groups and cause self-dispersing and, as a result, an anionic microencapsulated pigment is formed in which the organic pigment is used as a core material, the carboxyl-group-containing organic polymer compound is used as a wall material, and the organic pigment is covered with the anionic-group-containing organic polymer compound. Thus, the phase-inversion emulsification method is a method for producing an anionic-microencapsulated-pigment-containing water-based pigment dispersion in which an organic pigment is covered with a carboxyl-group-containing organic polymer compound and the formation of microparticles in an aqueous medium and the formation of capsule walls are simultaneously performed.

The acid precipitation method is described in Japanese Patent No. 3829370. This method is a method for producing an anionic-microencapsulated-pigment-containing water-based pigment dispersion in which an organic pigment is covered with a carboxyl-group-containing organic polymer compound by neutralizng a part of or the entirety of carboxyl groups with a basic compound without drying water-containing cake provided by a production method including a step of neutralizing a part of or the entirety of the carboxyl groups of the carboxyl-group-containing organic polymer compound with a basic compound and kneading the polymer compound with the organic pigment in a water-based medium and a step of making pH be neutral or acidic with an acidic compound such as hydrochloric acid to precipitate and fix carboxyl-group-containing organic polymer compounds onto the pigment.

When the phase-inversion emulsification method and the acid precipitation method are compared with each other, the acid precipitation method is preferred because metal components contained in the resultant water-based pigment dispersion can be readily reduced. The content of such metal components considerably influences the ejection property of inkjet printers. In particular, for printers having nozzles conducting thermal-system ejection, water-based inks having the content as low as possible are preferably used.

In the method for producing an anionic-microencapsulated-pigment-containing water-based pigment dispersion in which an organic pigment is covered with a carboxyl-group-containing organic polymer compound, compared with the use of the polyurethane resin, when the copolymer is used for microencapsulating and dispersing the organic pigment in a water-based medium, high dispersion stability of the organic pigment (A) can be ensured and, while the stability is maintained, high resistance to scratching in color recording images can be obtained.

At this time, as for the polyurethane resin, an aqueous dispersion of the polyurethane resin not containing the organic pigment (A), the polyurethane resin being smaller than the average diameter of dispersed particles of an inkjet recording water-based pigment dispersion or water-based ink obtained by dispersing the organic pigment (A) with a copolymer, is preferably made to be contained in the water-based pigment dispersion or water-based ink, in view of the dispersion stability of the finally obtained water-based pigment dispersion or water-based ink.

Thus, the inventors of the present invention have found that it is preferred that an inkjet recording water-based pigment dispersion or water-based ink is prepared in advance with the organic pigment (A), the copolymer, and water that serve as essential components; and an aqueous dispersion of the polyurethane resin not containing the organic pigment (A) and having finer particles is added thereto to prepare the final inkjet recording water-based pigment dispersion or water-based ink.

In this way, when the copolymer of (meth)acrylic acid and another ethylenically unsaturated monomer that is copolymerizabie with the (meth) acrylic acid and an anionic-group-containing polyurethane resin are used in combination as the anionic-group-containing organic polymer compound (B), the former and the latter are preferably used with former/latter=95/5 to 5/95 in terms of non-volatile matter on a mass basis because resistance to scratching in color recording images and the dispersion stability of a water-based ink itself can be achieved. Note that, in an inkjet recording water-based ink according to the present invention, non-volatile matter of the anionic-group-containing organic polymer compound (B)/organic pigment (A) on a mass basis is preferably made within the above-described range.

Due to a water based pigment dispersion according to the present invention, an inkjet recording water-based ink according to the present invention is excellent in terms of ejection durability for continuous printing and provides color recording images that are excellent in terms of color development property and light, resistance.

The thus-obtained inkjet recording water-based ink according to the present invention can provide desired color recording images by printing under publicly known and commonly used conditions. A water-based ink according to the present invention in combination with a yellow water-based ink similarly obtained with a publicly known and commonly used yellow organic pigment such as C.I. Pigment Yellow 74 as an organic pigment (A), a cyan water-based ink similarly obtained with a publicly known and commonly used cyan organic pigment such as C. I. Pigment Blue 15:3 as an organic pigment (A), and a black water-based ink similarly obtained with a publicly known and commonly used black pigment such as carbon black, can provide desired YMCK full-color recording images.

An inkjet recording water-based ink according to the present invention in combination with a polyvalent metal salt solution can provide desired color recording images that are more excellent in terms of color development property. This is an inkjet recording water-based ink set according to the present invention, the ink set including a polyvalent metal salt solution and the inkjet recording water-based ink. Hereinafter, a printing system with this ink set will be referred to as a PgR system.

An ink set according to the present invention includes the water-based ink and a polyvalent metal salt solution. This polyvalent metal salt solution is a solution in which a polyvalent metal salt dissolves in a liquid medium.

The polyvalent metal salt is not particularly restricted; however, examples thereof include CaCl₂, Ca (NO₃)₂, CaI₂, CaBr₂, Ca (ClO₃)₂, Ca(C₂H₃O₂)₂, Ca(C₃H₅O₃)₂, CuCl₂, Cu (NO₃)₂, CuBr₂, Cu(ClO₃)₂, (C₂H₃O₂) NiCl₂, Ni(NO₃)₂, NiI₂, NiBr₂, Ni(C₂H₃O₂)₂, MgCl₂, Mg(NO₃)₂, MgI₂, MgBr₂, Mg(ClO₃)₂, Mg(C₂H₃O₂)₂, ZnCl₂, Zn(NO₃)₂, ZnI₂, ZnBr₂, Zn (ClO₃)₂, Zn (C₂H₃O₂)₂, BaCl₂, BaI₂, BaBr₂, Ba(ClO₃)₂, Ba(C₂H₃O₂)₂, Al(NO₃)₃, Cr(NO₃)₃, Cr(C₂H₃O₂)₃, FeCl₃, Fe(NO₃)₃, FeI₃, and FeBr₃. Such a polyvalent metal salt is preferably colorless or pale in the form of a solution prepared by being dissolved in a liquid medium. Such a polyvalent metal salt is preferably a Mg salt, which tends to provide a high color development property, compared with a Ca salt in terms of an identical fixing amount of a solution having an identical mass % concentration.

A polyvalent metal salt solution according to the present invention preferably has a polyvalent metal salt content in the range of 0.5 to 20% in terms of mass and, in particular, more preferably in the range of 1 to 10%. When such a range is satisfied, improvement in image quality such as a color development property is achieved and there is a low probability of, for example, degradation in storage stability or ejection stability or corrosion of components of a recording head, which is preferable.

A polyvalent metal salt solution can be prepared by, for example, dissolving a predetermined water-soluble polyvalent metal salt in water, hot water, a water-based liquid medium, or the like. As the water-based liquid medium, a solvent mixture composed of water and a water-soluble organic solvent can be used.

In the present invention, by using, in a water-based ink, a reaction between anionic groups of an anionic-group-containing organic polymer compound and polyvalent metal ions in a polyvalent metal salt solution, the fixability or color development property of color recording images on plain paper sheets is enhanced. In view of such a respect, as the water, water similar to that in the preparation of a water-based ink is preferably used.

If necessary, a polyvalent metal salt solution in the present invention can be appropriately made to contain the above-described additives that are publicly known and commonly used and can be used for the preparation of a water-based ink. A polyvalent metal salt solution may be prepared in the manner of preparing a water-based ink in which the organic pigment (A) and the anionic-group-containing organic polymer compound (B) are replaced by a necessary amount of a polyvalent metal salt. A water-based ink and a polyvalent metal salt solution may be made to contain, in common, a liquid medium, additive, or the like.

As for an inkjet recording water-based ink set according to the present invention, a polyvalent metal salt solution and the water-based ink (X) are preferably prepared such that the surface tension of the polyvalent metal salt solution is higher than the average surface tension of the water-based ink (X) because advantages of the present invention can be enhanced.

A water-based ink and a polyvalent metal salt solution that are used in the present invention are used for inkjet recording. Accordingly, these are preferably prepared so as to have an appropriate viscosity with which these can be ejected in accordance with a nozzle system of an inkjet recording apparatus.

An inkjet recording water-based ink set according to the present invention may be constituted by a single magenta water-based ink and a polyvalent metal salt solution, may be constituted by YMCK four-color water-based inks and a polyvalent metal salt solution, or may be constituted by five-color to seven-color water-based inks including the YMCK water-based inks and another color water-based ink and a polyvalent metal salt solution.

The case where an inkjet recording water-based ink set according to the present invention is constituted by a single-color water-based ink containing a red pigment composed of a disubstituted quinacridone and C.I. Pigment Red 269 and a polyvalent metal salt solution, the case where the ink set is constituted by YMCK four-color water-based inks including the single-color water-based ink and a polyvalent metal salt solution, and the case where the ink set is constituted by five-color to seven-color water-based inks including the YMCK water-based inks including at least one color water-based ink among the foregoing and another color water-based ink and a polyvalent metal salt solution, are preferable because advantages of the present invention are most remarkably achieved.

In the present invention, inkjet recording can be performed by making the above-described water-based ink and a polyvalent metal salt solution adhere to a recording medium by an inkjet recording system. As a result, a recorded product in which a color recording image is recorded on a recording medium is provided.

An inkjet recording method in which a water-based ink and a polyvalent metal salt solution are made to adhere to a recording medium by an inkjet recording system is not particularly restricted; however, the method may be, for example, a method in which a water-based ink and a polyvalent metal salt solution are simultaneously ejected and, before reaching a recording medium, mixed (brought into contact with each other) and the mixture of these is made to be fixed on the recording medium; or a method in which, after a polyvalent metal salt solution is elected and fixed on a recording medium, a water-based ink is elected and fixed thereon. In particular, the former method is preferably selected because inkjet recording time can be decreased and the color development property of color recording images can be enhanced.

In the latter method, the time between the ejection of a polyvalent metal salt solution and the election of a water-based ink varies in accordance with ejection amount, the type of a recording medium, or the like; however, the time is preferably 5 ms to 60 s and, more preferably 50 ms to 500 ms (ms represents 1/1000 s). When the time lag is shorter than 5 ms, before droplets of a polyvalent metal salt solution having been ejected permeate inside a recording medium, the droplets may come into contact with droplets of a water-based ink and hence the droplets are over the recording medium and there is a possibility of image quality or drying property being adversely influenced. In contrast, when the time lag is more than 60 s, droplets of a polyvalent metal salt solution completely permeate inside a recording medium and then come into contact with droplets of a water-based ink. Thus, there is a possibility of desired advantages of enhancing image quality not being achieved.

Note that a polyvalent metal salt solution may be fixed with an adhesion amount uniformly onto the entire surface of a recording medium, or may be selectively fixed onto areas where a water-based ink is fixed.

To form an agglomeration film by bringing a polyvalent metal salt solution and a water-based ink, into contact with each other to cause reaction, both of them are preferably made to adhere to a recording medium by an inkjet recording system such that at least the absolute magnitude of phosphate groups in droplets of the water-based ink for forming a color recording image is equal to the absolute magnitude of polyvalent metal ions in droplets of the polyvalent metal salt solution for forming the color recording image.

In the present invention, by performing inkjet recording on a recording medium, a recorded product in which a color recording image is formed on the recording mediums can be provided.

An inkjet recording water-based ink set according to the present invention can be used for an inkjet recording method on publicly known and commonly used recording media. In such a case, the recording media may be various films and sheets, for example, plain paper sheets such as PPC paper sheets, paper sheets specifically designed for inkjet recording such as photo paper sheets (glossy) or photo paper sheets (matte), synthetic resin films such as OHP films, and metal foils such as aluminum foils. In particular, an inkjet recording water-based ink set according to the present invention is effective for enhancing the color development, property of color recording images on plain paper sheets. In plain paper sheets that are made of thick fibers made from softwood pulp, the enhancement of color development property is most effectively achieved.

As described above, as for an inkjet recording water-based ink set according to the present invention, for example, color recording images are formed with a water-based ink and a polyvalent metal salt solution in inkjet recording for plain paper sheets serving as recording media while color recording images are formed with a water-based ink only in inkjet recording for specifically designed paper sheets serving as recording media. As a result, the color development level of color recording images on inexpensive plain paper sheets can be made to be close to that on specifically designed paper sheets.

An inkjet recording water-based ink, set according to the present invention is excellent in terms of ejection durability for continuous printing and can provide color recording images that are excellent in terms of color development property and light resistance.

### EXPERIMENTAL EXAMPLES

Hereinafter, the present invention will be described in further detail with Experimental examples and Comparative examples. In the following Experimental examples and Comparative examples, “parts” and “%” are based on mass.

### (Synthesis of Dispersion Resin)

### <Water-Soluble Dispersion Resin R1>

The reaction vessel of an automatic polymerization apparatus (polymerization tester DEL-2AS, manufactured by TODOROKI SANGYO CO., LTD.) having the reaction vessel equipped with a stirrer, a dropping device, a temperature sensor, and a reflux device that has a nitrogen introduction device in an upper portion thereof was charged with 600 parts of methyl ethyl ketone (MEK). The reaction vessel was purged with nitrogen while being stirred. While the reaction vessel was kept to have the nitrogen atmosphere, the temperature thereof was increased to 80° C. Then, a mixed solution of 82 parts of benzyl methacrylate, 38 parts of 2-hydroxyethyl methacrylate, 115 parts of methacrylic acid, 250 parts of styrene, 15 parts of glycidyl methacrylate, 20 parts of thioglycerol, and 40 parts of “PERBUTYL (registered trademark) 0” (active substance: t-butyl peroxy 2-ethylhexanoate, manufactured by NOF CORPORATION) was dropped from the dropping device over 4 hours. After the dropping was completed, the reaction was allowed to continue for 15 hours at the same temperature. Then, a portion of MEK was evaporated under reduced pressure such that the non-volatile matter was adjusted to be 50%. Thus, a dispersion resin R1 having an acid value of 150 was obtained.

### (Preparation of Water-Based Pigment Dispersion)

### <Single-Pigment Water-Based Pigment Dispersion A1>

| | |
|---|---|
| FASTOGEN Super Magenta 1022 | 390.00 parts |
| (C.I. Pigment Red 269, manufactured by DIC) | |
| Water-soluble dispersion resin R1 | 361.45 parts |
| 25% aqueous solution of potassium hydroxide | 96.83 parts |
| Ion-exchanged water | 971.73 parts |

These were mixed and the resultant mixed solution was passed through a dispersion apparatus (SC mill SC100/32, manufactured by MITSUI MINING COMPANY, LIMITED) filled with zirconia beads having a diameter of 0.3 mm and dispersed by a circulation system (a system in which a dispersion solution discharged from a dispersion apparatus is returned to the mixing tank). During the dispersion step, the temperature of the dispersion solution was controlled to be 30° C. or less by passing cold water through a cooling jacket.

After the dispersion was completed, an undiluted dispersion solution was extracted from the mixing tank. Then, 2,000 parts of water was used to wash the mixing tank and the channels of the dispersion apparatus and mixed with the undiluted dispersion solution to provide a diluted dispersion solution.

The diluted dispersion solution was put into a glass distillation device and the entire amount of methyl ethyl ketone and a portion of water were evaporated. After is was left to cool to room temperature, while being stirred, 2% hydrochloric acid was dropped to achieve adjustment to a pH of 4.5. Then, the solid matter was filtered with a Nutsche filtration equipment and rinsed. The wet cake was taken into a vessel, mixed with a 25% aqueous solution of potassium hydroxide to be prepared to a pH of 9.5, and dispersed again with a Disper (1K HOMO DISPER 20, manufactured by Tokushu Kika Kogyo Co., Ltd.). After that, a centrifugal separation step (6000 G, 30 minutes) was performed. Furthermore, ion-exchanged water was added to provide a water-based pigment dispersion A1 having a non-volatile matter content of 20%. This water-based pigment dispersion was a water-based pigment dispersion, containing a microencapsulated pigment in which C. I. Pigment. Red 269 was covered with a styrene-(meth)acrylate-(meth)acrylic acid copolymer.

### <Single-Pigment Water-Based Pigment Dispersion A2>

A water-based pigment dispersion A2 was obtained in the same manner as in the single-pigment dispersion A1 except that the pigment was replaced by CROMOPHTAL Jet. Magenta DMQ (C. I. Pigment Red 122, manufactured by Ciba). This water-based pigment dispersion was a water-based pigment dispersion containing a microencapsulated pigment in which C. I. Pigment Red 122 was covered with a styrene-(meth)acrylate-(meth)acrylic acid copolymer.

### <Blended Water-Based Pigment Dispersions A3 to A6>

Blended water-based pigment dispersions A3, A4, A5, and A6 having a non-volatile matter content of 20% were respectively obtained by mixing the single-pigment water-based pigment dispersions A1 and A2 such that A1/A2 (mixing ratio by mass) was 12.5%/87.5%, 25.0%/75.0%, 50.01/50.0%, and 75.0%/25.0%

### <Single-Pigment Water-Based Pigment Dispersion A7>

A water-based pigment dispersion A7 was obtained in the same manner as in the single-pigment water-based pigment dispersion A1 except that the pigment was replaced by 228-2120 (solid solution pigment of C. I. Pigment Violet 19 and C. I. Pigment Red 209, manufactured by Sun Chemical Company Ltd.). This water-based pigment dispersion was a water-based pigment dispersion containing a microencapsulated pigment in which the quinacridone solid solution pigment was covered with a styrene-(meth)acrylate-(meth)acrylic acid copolymer.

### <Blended Water-Based Pigment Dispersions A8 to A11>

Blended water-based pigment dispersions A8, A9, A10, and All having a non-volatile matter content of 20% were respectively obtained by mixing the single-pigment water-based pigment dispersions A1 and A7 such that A1/A7 (mixing ratio by mass) was 12.55/87.5%, 25.0%/75.0%, 50.0%/50.0%, and 75.05/25.0%.

### <Blended-Pigment Water-Based Pigment Dispersion A12>

A water-based pigment dispersion A12 was obtained in the same manner as in the single-pigment dispersion A1 except that the pigment used was a mixture of FASTOGEN Super Magenta 1022 (C. I. Pigment Red 269, manufactured by DIC) and CROMOPHTAL jet Magenta DMQ (C. I. Pigment Red 122, manufactured by Ciba) that had been mixed in advance with a mixing ratio by Mass of 25.05/75.0%. This water-based pigment dispersion was a water-based pigment dispersion containing a microencapsulated pigment in which C. I. Pigment Red 122 and C. I. Pigment Red 269 were covered with a styrene-(meth)acrylate-(meth)acrylic acid copolymer.

### <Blended-Pigment Water-Based Pigment Dispersion A13>

A water-based pigment dispersion A13 was obtained in the same manner as in the single-pigment dispersion A1 except that the pigment used was a mixture of FASTOGEN Super Magenta 1022 (C. I. Pigment Red 269, manufactured by DIC) and 228-2120 (solid, solution pigment of C. I. Pigment Violet 19 and C. I. Pigment Red 209, manufactured by Sun Chemical Company Ltd.) that had been mixed in advance with a mixing ratio by mass of 25.05/75.0%. This water-based pigment dispersion was a water-based pigment dispersion containing a microencapsulated pigment in which the quinacridone solid solution pigment and C. I. Pigment Red 269 were covered with a styrene-(meth)acrylate-(meth)acrylic acid copolymer.

### Experimental Example 1

The single-pigment water-based pigment dispersion A1 was used to prepare an inkjet recording water-based ink a1 having a pigment content ratio of FASTOGEN Super Magenta 1022:CROMOPHTAL Jet Magenta DMQ=100:0. The ink composition is described below. The prepared water-based ink a1 was used and the physical property values were measured.

### (Ink Composition)

| | |
|---|---|
| Water-based pigment dispersion A1 | Amount that was 3.0 |
| | parts in terms of pigment |
| Glycerin | 10.0 parts |
| Triethylene glycol monobutyl ether | 10.0 parts |
| 2-pyrrolidone | 5.0 parts |
| Surfynol 465 (manufactured by Air | 0.5 parts |
| Products and Chemicals, Inc.) | |
| Ion-exchanged water | Remainder |

### Experimental Example 2

An inkjet recording water-based ink A2 satisfying FASTOGEN Super Magenta 1022:CROMPHTAL Jet Magenta DMQ=0:100 (5) was prepared in the same manner as in Experimental example 1 except that the single-pigment water-based pigment dispersion A2 was used. The prepared water-based ink a2 was used and the physical property values were measured.

### Experimental Example 3

An inkjet recording water-based ink a3 satisfying FASTOGEN Super Magenta 1022:CROMOPHTAL Jet Magenta. DMQ=12.5:87.5(%) was prepared in the same manner as in Experimental example 1 except that the blended-pigment water-based pigment dispersion A3 was used. The prepared water-based ink a3 was used and the physical property values were measured.

### Experimental Example 4

An inkjet recording water-based ink a4 satisfying FASTOGEN Super Magenta 1022:CROMOPHTAL Jet Magenta DMQ=25.0:75.0(%) was prepared in the same manner as in Experimental example 1 except that the blended-pigment water-based pigment dispersion A4 was used. The prepared water-based ink a4 was used and the physical property values were measured.

### Experimental Example 5

An inkjet recording water-based ink a5 satisfying FASTOGEN Super Magenta 1022:CROMOPHTAL Jet Magenta DMQ=50.0:50.0(%) was prepared in the same manner as in Experimental example 1 except that the blended-pigment water-based pigment dispersion A5 was used. The prepared water-based ink a5 was used and the physical property values were measured.

### Experimental Example 6

An inkjet recording water-based ink a6 satisfying FASTOGEN Super Magenta 1022:CROMPHTAL Jet Magenta DMQ=75.0:25.0(%) was prepared in the same manner as in Experimental example 1 except that the blended-pigment water-based pigment dispersion A6 was used. The prepared water-based ink a6 was used and the physical property values were measured.

### Comparative Example 1

From the physical property values of the single-pigment water-based ink a1 and the single-pigment water-based ink a2, the arithmetic mean in FASTOGEN Super Magenta 1022:CROMOPHTAL Jet Magenta DMQ=12.5:87.5 (6) was calculated. The calculation was performed as follows.

<a1>×12.5%+<a2>×87.5%

### Comparative Example 2

From the physical property values of the single-pigment water-based ink a1 and the single-pigment water-based ink a2, the arithmetic mean in FASTOGEN Super Magenta 1022:CROMOPHTAL Jet Magenta DMQ=25.0%:75.0% was calculated. The calculation was performed as follows.

<a1>×25.0%+<a2>×7.0%

### Comparative Example 3

From the physical property values of the single-pigment water-based ink a1 and the single-pigment water-based ink a2, the arithmetic mean in FASTOGEN Super Magenta 1022:CROMOPHTAL Jet Magenta DMQ=50.0%:50.0% was calculated. The calculation was performed as follows.

<a1>×50.0%+<a2>×50.0%

### Comparative Example 4

From the physical property values of the single-pigment water-based ink a1 and the single-pigment water-based ink a2, the arithmetic mean in FASTOGEN Super Magenta 1022:CROMOPHTAL Jet Magenta DMQ=75.05:25.0% was calculated. The calculation was performed as follows.

<a1>×75.0%+<a2;>×25.0%

### Experimental Example 7

An inkjet recording single-pigment water-based ink a7 satisfying FASTOGEN Super Magenta 1022:228-2120=0%:100% was prepared in the same manner as in Experimental example 1 except that the single-pigment water-based pigment dispersion A7 was used. The prepared water-based ink a7 was used and the physical property values were measured.

### Experimental Example 8

An inkjet recording water-based ink a8 of a blended water-based pigment dispersion, satisfying FASTOGEN Super Magenta 1022: 228-2120=12.5%:87.5% was prepared in the same manner as in Experimental example 1 except that the blended water-based pigment dispersion A8 was used. The prepared water-based ink a8 was used and the physical property values were measured.

### Experimental Example 9

An inkjet recording water-based ink a9 of a blended water-based pigment dispersion, satisfying FASTOGEN Super Magenta 1022:228-2120=25.0%:75.0% was prepared in the same manner as in Experimental example 1 except that the blended water-based pigment dispersion A9 was used. The prepared water-based ink a9 was used and the physical property values were measured.

### Experimental Example 10

An inkjet recording water-based ink a10 of a blended water-based pigment dispersion, satisfying FASTOGEN Super Magenta 1022:228-2120=50.01:50.0% was prepared in the same manner as in Experimental example 1 except that the blended water-based pigment dispersion A10 was used. The prepared water-based ink a10 was used and the physical property values were measured.

### Experimental Example 11

An inkjet recording water-based ink a11 of a blended water-based pigment dispersion, satisfying FASTOGEN Super Magenta 1022:228-2120=75.01:25.0% was prepared in the same manner as in Experimental example 1 except that the blended water-based pigment dispersion All was used. The prepared water-based ink a11 was used and the physical property values were measured.

### Comparative Example 5

From the physical property values of the single-pigment water-based ink a1 and the single-pigment water-based ink a7, the arithmetic mean in FASTOGEN Super Magenta 1022:228-2120-12.51:87.5% was calculated. The calculation was performed as follows.

<a1>×12.5%+<a7>×87.5%

### Comparative Example 6

From the physical property values of the single-pigment water-based ink a1 and the single-pigment water-based ink a7, the arithmetic mean in FASTOGEN Super Magenta 1022:228-2120=25.0%:75.0% was calculated. The calculation was performed as follows.

<a1>×25.0%+<a7>×7.0%

### Comparative Example 7

From the physical property values of the single-pigment water-based ink a1 and the single-pigment water-based ink a7, the arithmetic mean in FASTOGEN Super Magenta 1022:228-2120=50.0%:50.0% was calculated. The calculation was performed as follows.

<a1>×50.0%+<a7>×500%

### Comparative Example 8

From the physical property values of the single-pigment water-based ink a1 and the single-pigment water-based ink a7, the arithmetic mean in FASTOGEN Super Magenta 1022:228-2120=75.0%:25.0% was calculated. The calculation was performed as follows.

<a1>×75.0%+<a7>×25.0%

### Comparative Example 9

An inkjet recording water-based ink a12 satisfying FASTOGEN Super Magenta 1022:CROMOPHTAL Jet Magenta DMQ=25:75(%) was prepared in the same manner as in Experimental example 1 except that the blended-pigment water-based pigment dispersion A12 was used. The prepared water-based ink a12 was used and the physical property values were measured.

### Comparative Example 10

An inkjet recording water-based ink a12 satisfying FASTOGEN Super Magenta 1022:228-2120=25:75(%) was prepared in the same manner as in Experimental example 1 except that the blended-pigment water-based pigment dispersion A13 was used. The prepared water-based ink a12 was used and the physical property values were measured.

### (Color Development Property in Blending)

The inkjet recording water-based inks a1 to a11 were charged into cartridges for a commercially available inkjet printer (BJ F360, manufactured by Canon Inc.). As for media, plain paper sheets (GF-500, manufactured by Canon Inc.) were used; and the case where printing was simply performed (single-liquid printed products) and the case where a transparent ink composed of a polyvalent metal salt solution was applied with a commercially available PgR-printer-system inkjet printer (PIXUS MX 7600) in advance and then printing was performed (two-liquid printed products) were performed. Note that the printing was performed with a Duty of 100%.

The optical reflection density (O. D.) of patches of the single-liquid printed products and the two-liquid printed products was measured with a spectrophotometer SpetroEye.

TABLE 1

| | | | Color optical density (O.D.) | |
|---|---|---|---|---|
| | | Azo pigment | Single-liquid | Two-liquid |
| | Quinacridone | blending | printed | printed |
| | pigment | percentage | product | product |
| Experimental | C.I. Pigment | 0% | 0.874 | 1.25 |
| example 2 | Red 122 | | | |
| Experimental | | 12.5% | 0.885 | 1.34 |
| example 3 | | | | |
| Experimental | | 25% | 0.895 | 1.41 |
| example 4 | | | | |
| Experimental | | 50% | 0.916 | 1.46 |
| example 5 | | | | |
| Experimental | | 75% | 0.932 | 1.49 |
| example 6 | | | | |
| Experimental | | 100% | 0.948 | 1.50 |
| example 1 | | | | |
| Comparative | | 12.5% | 0.884 | 1.28 |
| example 1 | | | | |
| Comparative | | 25% | 0.893 | 1.31 |
| example 2 | | | | |
| Comparative | | 50% | 0.911 | 1.38 |
| example 3 | | | | |
| Comparative | | 75% | 0.930 | 1.44 |
| example 4 | | | | |
| Comparative | | 25% | 0.875 | 1.28 |
| example 9 | | | | |

TABLE 2

| | | Azo | Color optical density (O.D.) | |
|---|---|---|---|---|
| | | pigment | Single-liquid | Two-liquid |
| | Quinacridone | blending | printed | printed |
| | pigment | percentage | product | product |
| Experimental | Solid solution of | 0% | 0.897 | 1.34 |
| example 7 | C.I. Pigment | | | |
| Experimental | Red 202 and C.I. | 12.5% | 0.905 | 1.38 |
| example 8 | Pigment Violet 19 | | | |
| Experimental | | 25% | 0.913 | 1.41 |
| example 9 | | | | |
| Experimental | | 50% | 0.925 | 1.45 |
| example 10 | | | | |
| Experimental | | 75% | 0.935 | 1.48 |
| example 11 | | | | |
| Experimental | | 100% | 0.947 | 1.50 |
| example 1 | | | | |
| Comparative | | 12.5% | 0.903 | 1.36 |
| example 5 | | | | |
| Comparative | | 25% | 0.910 | 1.38 |
| example 6 | | | | |
| Comparative | | 50% | 0.922 | 1.42 |
| example 7 | | | | |
| Comparative | | 75% | 0.935 | 1.46 |
| example 8 | | | | |
| Comparative | | 25% | 0.901 | 1.35 |
| example 10 | | | | |

### (Light Resistance in Blending)

The inkjet recording water-based inks a1 to a11 were charged into cartridges for a commercially available inkjet printer (PX A-550, manufactured by SEIKO EPSON CORPORATION). As for media, plain paper sheets (GF-500, manufactured by Canon. Inc.) were used; and the case where printing was simply performed (single-liquid printed products) and the case where a transparent ink composed of a polyvalent metal salt solution was applied with a commercially available PgR-printer-system inkjet printer (PIXUS MX7600) in advance and then printing was performed (two-liquid printed products) were performed.

The printing was performed on both media with a Duty of 100%. The optical reflection density (O. D.) of patches was measured with a spectrophotometer SpetroEye and the hue was further measured with a spectrophotometer SF600.

The printed products were irradiated with ultraviolet rays for 150 hours with a fade meter. Then, the optical reflection density and the hue were measured again in the same manner. From the results, density variation (ΔO. D.) and color difference (ΔE*ab) were calculated.

The results of the density variation (ΔO. D.) are summarized in Table 3 and Table 4. The results of the color difference (ΔE*ab) are summarized in Table 5 and Table 6.

TABLE 3

| | | | Density variation (ΔO.D.) | |
|---|---|---|---|---|
| | | Azo pigment | Single-liquid | Two-liquid |
| | Quinacridone | blending | printed | printed |
| | pigment | percentage | product | product |
| Experimental | C.I. Pigment | 0% | 0.05 | 0.05 |
| example 2 | Red 122 | | | |
| Experimental | | 12.5% | 0.03 | 0.09 |
| example 3 | | | | |
| Experimental | | 25% | 0.13 | 0.13 |
| example 4 | | | | |
| Experimental | | 50% | 0.24 | 0.23 |
| example 5 | | | | |
| Experimental | | 75% | 0.38 | 0.37 |
| example 6 | | | | |
| Experimental | | 100% | 0.59 | 0.60 |
| example 1 | | | | |
| Comparative | | 12.5% | 0.12 | 0.12 |
| example 1 | | | | |
| Comparative | | 25% | 0.19 | 0.19 |
| example 2 | | | | |
| Comparative | | 50% | 0.32 | 0.33 |
| example 3 | | | | |
| Comparative | | 75% | 0.46 | 0.46 |
| example 4 | | | | |
| Comparative | | 25% | 0.12 | 0.13 |
| example 9 | | | | |

TABLE 4

| | | Azo | Density variation (ΔO.D.) | |
|---|---|---|---|---|
| | | pigment | Single-liquid | Two-liquid |
| | Quinacridone | blending | printed | printed |
| | pigment | percentage | product | product |
| Experimental | Solid solution of | 0% | 0.04 | 0.04 |
| example 7 | C.I. Pigment | | | |
| Experimental | Red 202 and C.I. | 12.5% | 0.06 | 0.06 |
| example 8 | Pigment Violet 19 | | | |
| Experimental | | 25% | 0.09 | 0.10 |
| example 9 | | | | |
| Experimental | | 50% | 0.19 | 0.20 |
| example 10 | | | | |
| Experimental | | 75% | 0.32 | 0.31 |
| example 11 | | | | |
| Experimental | | 100% | 0.50 | 0.51 |
| example 1 | | | | |
| Comparative | | 12.5% | 0.10 | 0.10 |
| example 5 | | | | |
| Comparative | | 25% | 0.16 | 0.16 |
| example 6 | | | | |
| Comparative | | 50% | 0.27 | 0.28 |
| example 7 | | | | |
| Comparative | | 75% | 0.39 | 0.39 |
| example 8 | | | | |
| Comparative | | 25% | 0.09 | 0.09 |
| example 10 | | | | |

TABLE 5

| | | | Color difference (ΔE*ab) | |
|---|---|---|---|---|
| | | Azo pigment | Single-liquid | Two-liquid |
| | Quinacridone | blending | printed | printed |
| | pigment | percentage | product | product |
| Experimental | C.I. Pigment | 0% | 4.21 | 4.44 |
| example 2 | Red 122 | | | |
| Experimental | | 12.5% | 5.21 | 5.10 |
| example 3 | | | | |
| Experimental | | 25% | 7.37 | 7.01 |
| example 4 | | | | |
| Experimental | | 50% | 12.87 | 12.85 |
| example 5 | | | | |
| Experimental | | 75% | 23.52 | 23.33 |
| example 6 | | | | |
| Experimental | | 100% | 41.13 | 41.08 |
| example 1 | | | | |
| Comparative | | 12.5% | 8.97 | 9.02 |
| example 1 | | | | |
| Comparative | | 25% | 13.59 | 13.74 |
| example 2 | | | | |
| Comparative | | 50% | 22.67 | 22.76 |
| example 3 | | | | |
| Comparative | | 75% | 31.90 | 31.92 |
| example 4 | | | | |
| Comparative | | 25% | 8.11 | 7.95 |
| example 9 | | | | |

TABLE 6

| | | Azo | Color difference (ΔE*ab) | |
|---|---|---|---|---|
| | | pigment | Single-liquid | Two-liquid |
| | Quinacridone | blending | printed | printed |
| | pigment | percentage | product | product |
| Experimental | Solid solution of | 0% | 4.61 | 4.58 |
| example 7 | C.I. Pigment | | | |
| Experimental | Red 202 and C.I. | 12.5% | 5.20 | 5.23 |
| example 8 | Pigment Violet 19 | | | |
| Experimental | | 25% | 6.94 | 6.90 |
| example 9 | | | | |
| Experimental | | 50% | 12.43 | 12.66 |
| example 10 | | | | |
| Experimental | | 75% | 21.88 | 21.66 |
| example 11 | | | | |
| Experimental | | 100% | 39.02 | 38.99 |
| example 1 | | | | |
| Comparative | | 12.5% | 8.91 | 8.88 |
| example 5 | | | | |
| Comparative | | 25% | 13.35 | 13.32 |
| example 6 | | | | |
| Comparative | | 50% | 21.82 | 21.78 |
| example 7 | | | | |
| Comparative | | 75% | 30.42 | 30.38 |
| example 8 | | | | |
| Comparative | | 25% | 7.03 | 6.98 |
| example 10 | | | | |

### (Color Optical Density Evaluation)

As for Experimental examples 1 to 6 and Comparative examples 1 to 4, a color development property was evaluated. The color development property was evaluated in terms of O. D. values in the two-liquid as follows.

| | |
|---|---|
| O.D. of 1.40 or more | A |
| O.D. of 1.30 or more and less than 1.40 | B |
| O.D. of less than 1.30 | C |

(Light Resistance Evaluation)

As for Experimental examples 1 to 6 and Comparative examples 1 to 4, light resistance was evaluated. The light resistance was evaluated in terms of color difference (ΔE*ab) values as follows.

| | |
|---|---|
| Color difference of less than 10.0 | A |
| Color difference of 10.0 or more and less than 25.0 | B |
| Color difference of 25.0 or more | C |

(Ejection Durability Evaluation)

The inkjet recording pigment inks a1 to a11 were charged into cartridges for a commercially available inkjet printer (BJ F360, manufactured by Canon. Inc.). As for media, plain paper sheets (GF-500, manufactured by Canon Inc.) were used. The printer was used and 250 lines in total were printed at a pitch of 1 mm per plain paper sheet, the lines having a width of 20 cm. This printing was continuously performed.

The continuous printing was performed in which 50 sheets were regarded as a set up to 150 sheets in total and, after that, 100 sheets were regarded as a set. When lines of printed products had defects, the number of the defective printed products was counted for each set. When the number of defective sheets was more than 50 in 100 sheets for two consecutive sets, the printing was terminated.

As for the election durability evaluation of the inks, the evaluation was performed in terms of the total number of printed sheets. Inc evaluation method was as follows.

| | |
|---|---|
| 3,000 or more printed sheets in total | A |
| 1,500 or more and less than 3,000 printed sheets in total | B |
| less than 1,500 printed sheets in total | C |

### (Summary)

The evaluation results of Experimental examples 1 to 11 and Comparative examples 1 to 8 in terms of color optical density, light resistance, and election durability are summarized in Tables 7 to 11 below.

Note that these Experimental examples 3 to 6 and Experimental examples 8 to 11 correspond to examples according to the present invention.

TABLE 7

| | Experimental | Experimental | Experimental |
|---|---|---|---|
| | example 1 | example 2 | example 7 |
| | C.I. Pigment | C.I. Pigment Red | Solid |
| Single pigment | Red 269 | 122-based | solution-based |
| Color development | A | C | B |
| property | | | |
| (O.D.) | | | |
| Light resistance | C | A | A |
| (color difference) | | | |
| Ejection durability | C | A | A |
| (number of printed | | | |
| sheets) | | | |

TABLE 8

| | Experimental | Comparative | | |
|---|---|---|---|---|
| Azo blending | example 3 | example 1 | Experimental | Comparative |
| percentage | C.I. Pigment | | example 8 | example 5 |
| 12.5% | Red 122-based | | Solid solution-based | |
| Color | B | C | B | B |
| development | | | | |
| property | | | | |
| (O.D.) | | | | |
| Light | A | A | A | A |
| resistance | | | | |
| (color | | | | |
| difference) | | | | |
| Ejection | A | A | A | A |
| durability | | | | |
| (number of | | | | |
| printed sheets) | | | | |

TABLE 9

| Azo blending | Experimental | Comparative | Comparative | Experimental | Comparative | Comparative |
|---|---|---|---|---|---|---|
| percentage | example 4 | example 2 | example 9 | example 9 | example 6 | example 10 |
| 25% | C.I. Pigment Red 122-based | | | Solid solution-based | | |
| Color | A | B | C | A | B | B |
| development | | | | | | |
| property | | | | | | |
| (O.D.) | | | | | | |
| Light | A | B | B | A | B | B |
| resistance | | | | | | |
| (color | | | | | | |
| difference) | | | | | | |
| Ejection | A | A | C | A | A | C |
| durability | | | | | | |
| (number of | | | | | | |
| printed sheets) | | | | | | |

TABLE 10

| | Experimental | Comparative | | |
|---|---|---|---|---|
| Azo blending | example 5 | example 3 | Experimental | Comparative |
| percentage | C.I. Pigment | | example 10 | example 7 |
| 50% | Red 122-based | | Solid solution-based | |
| Color | A | B | A | A |
| development | | | | |
| property (O.D.) | | | | |
| Light resistance | B | B | A | B |
| (color | | | | |
| difference) | | | | |
| Ejection | B | B | B | B |
| durability | | | | |
| (number of | | | | |
| printed sheets) | | | | |

TABLE 11

| | Experimental | Comparative | | |
|---|---|---|---|---|
| Azo blending | example 6 | example 4 | Experimental | Comparative |
| percentage | C.I. Pigment | | example 11 | example 8 |
| 75% | Red 122-based | | Solid solution-based | |
| Color | A | A | A | A |
| development | | | | |
| property | | | | |
| (O.D.) | | | | |
| Light | B | C | B | C |
| resistance | | | | |
| (color | | | | |
| difference) | | | | |
| Ejection | B | B | C | C |
| durability | | | | |
| (number of | | | | |
| printed sheets) | | | | |

In Table 9 above, Experimental example 4 means the characteristics of a mixture of single-pigment water-based pigment dispersions, and Comparative example 2 and Comparative example 9 respectively mean the characteristics of a water-based pigment dispersion of a pigment mixture (values calculated on the basis of arithmetic mean) and the characteristics of a water-based pigment dispersion of a pigment mixture (actually measured values).

Similarly, Experimental example 9 means the characteristics of a mixture of single-pigment water-based pigment dispersions, and Comparative example 6 and Comparative example 10 respectively mean the characteristics of a water-based pigment dispersion of a pigment mixture (values calculated on the basis of arithmetic mean) and the characteristics of a water-based pigment dispersion of a pigment mixture (actually measured values).

By performing comparison between the two systems in which Experimental example and Comparative example form a pair in terms of color development property, light resistance, and ejection durability as in Table 9 below, excellent technical advantages of the present invention can be readily recognized.

From the results, in an inkjet recording water-based ink according to the present invention, a water-based pigment dispersion for an inkjet recording water-based ink is made by blending a water-based pigment dispersion of a red pigment (Q) composed of a disubstituted quinacridone and a water-based pigment dispersion of C. I. Pigment Red 269 (A) such that a pigment weight ratio (A/Q) is in the range of 12.5/87.5 to 75/25, as a result, the ink has not only conventional preparation of hue and chroma but also excellent color optical density and hence high quality images can be provided and ejection stability and light resistance are excellent; preferably in a weight ratio (A/Q) being in the range of 12.5/87.5 to 50/50, and more preferably in the range of 20/80 to 35/65, inkjet recording water-based inks that are balanced at a high level in terms of color optical density, light, resistance, and ejection durability are provided.

### INDUSTRIAL APPLICABILITY

A water-based pigment dispersion for an inkjet recording water-based ink according to the present invention employs, as water-based pigment dispersions, a red pigment composed of a disubstituted quinacridone and C. I. Pigment Red 269. Therefore, a water-based pigment dispersion for an inkjet recording water-based ink can be provided that is excellent in terms of ejection durability for continuous printing, which is unexpected in comparison with a water-based pigment dispersion mixture for an inkjet recording water-based ink, the mixture being prepared with the red pigments themselves, and that can provide color recording images that are excellent in terms of color development property and light resistance.

1. A water-based pigment dispersion for an inkjet recording water-based ink, comprising: an organic pigment (A) and an anionic-group-containing organic polymer compound (B) in a water-based medium (C), wherein, as the water-based pigment dispersion, a water-based pigment dispersion in which the organic pigment (A) is a red pigment composed of a disubstituted quinacridone and a water-based pigment dispersion in which the organic pigment (A) is C. I. Pigment Red 269 are used in combination.

2. The water-based pigment dispersion for an inkjet recording water-based ink according to claim 1, wherein the red pigment composed of the disubstituted quinacridone is at least one red pigment selected from the group consisting of C. I. Pigment Red 122, C. I. Pigment Red 202, and a quinacridone solid solution pigment including, in a chemical structure, at least one of C. I. Pigment Red 122 and C. I. Pigment Red 202.

3. The water-based pigment dispersion for an inkjet recording water-based ink according to claim 1, wherein the red pigment composed of the disubstituted quinacridone/the C. I. Pigment Red 269 (mass ratio) equals 90/10 to 20/80.

4. An inkjet recording water-based ink prepared by at least diluting the water-based pigment dispersion for an inkjet recording water-based ink according to claim 1 in a liquid medium.

5. An inkjet recording water-based ink set comprising a polyvalent metal salt solution and an inkjet recording water-based ink prepared by at least diluting the water-based pigment dispersion for an inkjet recording water-based ink according to claim 1 in a liquid medium.
